(19) United States
(12) Patent Application Publication
(10) Pub. No.: US 2006/0015395 A1
(43) Pub. Date: Jan. 19, 2006

(54) Automated parking system with interactive voice response

(76) Inventors: Stanley J. Wolfson, Denver, CO (US); David A. Goodwin, Lakewood, CO (US); Mark R. Fairchild, Arvada, CO (US)

Correspondence Address: LAWRENCE N. GINSBERG, 21 SAN ANTONIO, NEWPORT BEACH, CA, 92660-9112, US

(21) Appl. No.: 10/892,670

(22) Filed: Jul. 16, 2004

(51) Int. Cl. G06F 17/00

(52) U.S. Cl. 705/13

(57) ABSTRACT

An automated parking system including a data server module, an internet-based sign up module, an automated parking module, an enforcement module, and a payment module. The data server module includes a member information database that stores selected member information; a client information database for storing selected client information; a location database for containing listings of parking units administered by the automated parking system; and an activity database for containing a listing of parking unit and member activity. The internet-based sign up module is operatively connected to the member information database for entering and processing new selected member information and providing private member identification information. The private member identification information includes a member identifier and personal identifier. The automated parking module implements the steps of: i) determining whether a user is a valid member based on the selected member information in response to a placed parking unit inquiry; ii) prompting the user for a parking unit (e.g. space or lot) identifier (e.g. number) if the user is a valid member, iii) determining if the parking unit identifier is valid based on parking unit listings in the location database and prompting the user to confirm a purchase by entering a personal identifier (e.g. PIN); and, iv) completing the transaction if the correct personal identifier is entered. The enforcement module is operatively connected to the data server module for checking selected parking units and validating the amount of time a member can park in a specific parking unit based on the activity data. The payment module is operatively connected to the data server module for processing member activity for a selected time frame and providing a billing of the member in response thereto; and, for processing parking unit activity for a selected time frame and providing payment to the client in response thereto utilizing the selected client information.

### BACKGROUND OF THE INVENTION

1. Field of the Invention

The present invention relates to automated parking systems and more particularly to a parking system that integrates the internet, cellular phone and interactive voice response (IVR) systems to allow drivers to pay for parking in lots and at parking meters owned by participating agencies with a mere phone call.

2. Description of the Related Art

There are a number of patents in the prior art discussing the manner in which parking automobiles can be automated.

For example, U.S. Pat. No. 6,513,711 discloses a parking control system in which a user sends a code to a receiving computer via a telephone system when beginning and terminating a parking period. A vehicle reference, such as a bar code carried by the vehicle or the vehicle registration number, is used to identify the vehicle. Parking time billing is effected by a credit card number coupled to the user. When checking a parked vehicle, a car park attendant causes a control unit to read and store the vehicle reference for marked vehicles, and also to store the date and time. The control unit memory contents are transmitted to the receiving computer and are compared with vehicle parking information that was received by telephone. A parking fine is issued for parked vehicles not having properly commenced a parking period.

U.S. Pat. No. 6,577,248 discloses a parking control system in which a mobile telephone can be used in connection with the commencement and termination of a vehicle parking period. A user sends at least one user-specific code to a parking system receiving computer via a mobile telephone or via a public switched telephone system. At the commencement of the parking period, the parking zone concerned is reported to the parking system. A machine-readable, vehicle-specific code is stored in the computer and is tied to the user-specific code. The system includes a control unit which mechanically reads the vehicle-specific code and communicates with the computer and retrieves a list that contains information relating to vehicles that have commenced a parking period but have not yet terminated parking within a relevant parking zone. When the control unit requests the information relating to vehicles parked, within a parking zone through the medium of the communication, the computer functions to transfer corresponding information relating to one or more parking zones that are geographically close to the parking zone concerned at the same time as the requested information is transmitted to the control unit.

U.S. Pat. No. 6,559,776 discloses a parking status control system and method that allows a parking space, or plurality of parking spaces, to be automatically monitored to detect unauthorized occupancy. The system and method may be applied to metered parking spaces or to other situations where controlled access to a parking space or area is desired. The presence or lack of a vehicle in a monitored parking space is determined using a vehicle presence detector, which communicates a signal indicative of such presence to a central system. A user or vehicle based authorization module is configured to transmit an authorization input to facilitate automated satisfaction of a space authorization device, e.g., payment of a parking meter. If there is occupancy, but no proper authorization input, the central system declares a violation and communicates the violation to another system or individual charged with taking corrective action.

U.S. Pat. No. 6,646,568 discloses a parking control system that includes a parking controller. The parking controller receives and provides information to the plurality of vehicles. The parking controller can communicate the most appropriate parking space to the vehicle that is attempting to park. In a method and system in accordance with that invention, a parking controller monitors a parking lot and can be in direct contact with the vehicles. The parking controller receives and transmits information to and from the vehicles and allows for an overall view of the parking lot to be understood. Accordingly, through the use of the parking controller system, parking is controlled more accurately and automatically.

U.S. Pat. No. 6,519,329 discloses a parking system in which parking of a vehicle can be commenced and terminated through the medium of a mobile telephone, and where at the commencement and termination of a parking period a user of the system sends at least one code to a receiving computer via a mobile telephone system or a fixed telephone system, when a user wishes to connect himself/herself to the parking system in order to be able to park his/her vehicle with the aid of a telephone, either a pay meter, a cash card terminal or the like, mechanically reads a cash card owned by the user and accepted by the parking system as a means of payment. Data read from the card is stored in a database belonging to the computer of the parking company, and at least one user. Specific reference is stored in and tied together with the data in the database.

International Patent Publication No. WO 93/20539 discloses a vehicle parking system in which a parking period is commenced and terminated with the aid of a mobile telephone. There is sent at the commencement and termination of each parking period, via the mobile telephone, a code that identifies the parking place used, a code that identifies the vehicle concerned, and a code unique to the driver of the vehicle. It is proposed that the fee for parking the vehicle be billed through the standard telephone billing system.

U.S. Pat. No. 6,529,880 discloses an automatic payment system for a plurality of remote merchants.

There are prior art patents related to the telephony auto-attendants. For example, U.S. Pat. No. 6,628,758 discloses in general an automated attendant telephony directory system and more specifically to a combination of a directory system providing a non-linear search and an intuitive navigation scheme.

Other parking system related patents include: U.S. Pat. Nos. 6,493,676; 6,373,401; 6,249,233; 6,312,152; 6,340,935; 6,102,285; 6,085,124; 6,037,880; 5,905,247; 5,877,704; 5,877,704; 5,845,268; 5,737,710; 5,737,710; 5,414,624; 5,407,049; 5,351,187; 5,339,000; 5,266,947; 5,166,680; and, 5,029,094.

U.S. Pat. No. 6,327,363 discloses a method and system for automated customer services for product related services. U.S. Pat. No. 5,991,740 discloses a data processing system for integrated tracking and management of commerce related activities on a public access network.

U.S. Pat. No. 6,335,964 discloses an IVR voice processing system. U.S. Pat. No. 5,136,632 discloses a telephone service payment system using a sound emitting token. U.S. Pat. No. 6,289,315 discloses a credit card swipe system for the transportation industry. U.S. Pat. No. 6,195,015 discloses an electronic parking meter which is capable of performing a number of functions including detecting the presence of a parked vehicle. U.S. Pat. No. 5,337,347 discloses a method and system for progressive database search termination and dynamic information presentation utilizing telephone keypad input.

### SUMMARY OF THE INVENTION

In a broad aspect, the present invention is an automated parking system including a data server module, an internet-based sign up module, an automated parking module, an enforcement module, and a payment module. The data server module includes a member information database that stores selected member information; a client information database for storing selected client information; a location database for containing listings of parking units administered by the automated parking system; and an activity database for containing a listing of parking unit and member activity. The internet-based sign up module is operatively connected to the member information database for entering and processing new selected member information and providing private member identification information. The private member identification information includes a member identifier and personal identifier. The automated parking module implements the steps of: i) determining whether a user is a valid member based on the selected member information in response to a placed parking unit inquiry; ii) prompting the user for a parking unit (e.g. space or lot) identifier (e.g. number) if the user is a valid member, iii) determining if the parking unit identifier is valid based on parking unit listings in the location database and prompting the user to confirm a purchase by entering a personal identifier (e.g. PIN); and, iv) completing the transaction if the correct personal identifier is entered. The enforcement module is operatively connected to the data server module for checking selected parking units and validating the amount of time a member can park in a specific parking unit based on the activity data. The payment module is operatively connected to the data server module for processing member activity for a selected time frame and providing a billing of the member in response thereto; and, for processing parking unit activity for a selected time frame and providing payment to the client in response thereto utilizing the selected client information.

Use of the present invention has several advantages over prior art systems. The present parking system, known under the trademark Park-By-Phone™, allows drivers to pay for parking in lots and meters owned by participating agencies with a mere phone call. Parking fees are instantly validated and there is no longer a need to search for correct coins, cash, cards, or other means of payment.

The Park-by-Phone™ parking system brings together today's technologies, including the Internet, credit card payments, cellular phone service and interactive voice response (IVR). It has several advantages over the prior art systems. Unlike some of the other systems it does not use a cell phone to begin and end a parking event. Instead, it uses the phone to identify the space or lot. The present invention does not require vehicle detection and therefore does not require overhead or analogous equipment to identify the parking space. It does not use RFID tags or bar codes to identify the customer and reader location to identify charges. Instead it uses a cell phone and member number to identify customer and location.

The present invention uses IVR and touch tones to identify user by caller ID or member touch tone entry, space and PIN number. This is distinguished from, for example, U.S. Pat. No. 6,513,711 that relies on caller ID and a different incoming phone number for each location.

Unlike some of the other prior parking systems the present invention does not rely on any devices other than a printed tag to identify the member to parking enforcement. The present invention does not require special equipment, smart cards or prepayment. Furthermore, since an onboard device is not used it is not vehicle specific. A member can use his/her membership in any vehicle.

As a result of the efficiency of the invention and ease in enforcement and billing, use of the present system is profitable for municipal and private parking agencies.

### BRIEF DESCRIPTION OF THE DRAWINGS

FIG. 1 is block diagram of the overall system of the present invention.

FIG. 2A is a flow chart illustrating the initial steps in the IVR application of the automated parking module.

FIG. 2B is a flow chart illustrating the process steps in the IVR application when a meter is selected.

FIG. 2C is a flow chart illustrating the process steps in the IVR application when a previous transaction is requested to be repeated.

FIG. 2D is a flow chart illustrating the process steps in the IVR application when a query is submitted as to whether a member has an active transaction.

FIG. 3 illustrates a dashboard card used by the member.

FIG. 4 illustrates a lot sign posted by the client.

### DETAILED DESCRIPTION OF THE INVENTION

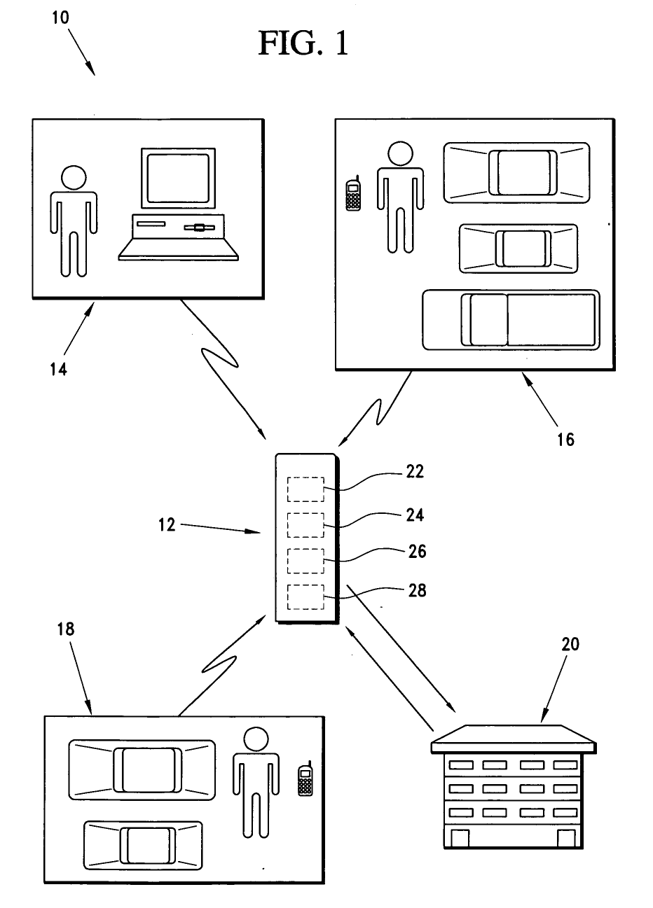

Referring now to the drawings and the characters of reference marked thereon, FIG. 1 illustrates a preferred embodiment of the automated parking system of the present invention, designated generally as 10. The automated parking system 10 includes a data server module 12, an internet-based sign up module 14, an automated parking module 16, an enforcement module 18 and a payment module 20.

The data server module 12 includes a member information database 22 for storing selected member information, a client information database 24 for storing selected client information, a location database 26 for containing listings of parking units administered by the automated parking system; and, an activity database 28 for containing a listing of parking unit and member activity. The selected member information preferably includes the member's name, address, phone number, e-mail, unique ID, and payment information. The selected client information similarly preferably includes the client's name, a unique ID, address, and phone number. The client is typically the company or agency that owns or administers the parking units. The parking units listed in the location database are typically parking spaces or parking meters. The activity database 28 includes activity database fields that preferably include a member ID field, a date/time field, a fee field and an identification field of the parking unit.

The internet-based sign up module 14 is operatively connected to the member information database for entering and processing new selected member information and providing private member identification information. The private member identification information includes a unique member identifier (e.g. number) and personal identifier (e.g. PIN). This information is preferably provided to the user via an e-mail which also preferably includes a temporary membership dashboard card.

In summary, the automated parking module 16 implements the steps of:

i. prompting a user for the member number in response to a placed parking telephone call or internet inquiry;

ii. determining if the member number is valid based on the selected member information;

iii. prompting the user for a parking unit (e.g. space or lot) identifier (e.g. number) if the member identifier is valid;

iv. determining if the parking unit identifier is valid based on parking unit listings in the location database and prompting the user to confirm a purchase by entering a personal identifier (e.g. PIN); and,

v. completing the transaction if the correct personal identifier is entered.

If the member's caller ID is in the system database some of the steps above are obviated and the member number is automatically retrieved from the database.

The enforcement module 18 is operatively connected to the data server module 12 for checking selected parking units and validating the amount of time a member can park in a specific parking unit based on the activity data. When an enforcement officer checks lots and meters they have three methods of validating the amount of time a car has left at the lot or meter:

1. Internet enabled Mobile Phone, Internet enabled wrist watch or PDA: Officer uses a web enabled phone to connect to the internet. He enters in a user name, and password to log-in. After he is logged in he can enter in a Group Event ID to view all vehicles currently active in the lot.

2. Mobile phone call in: Officer uses mobile phone to dial a specified number. An automatic attendant prompts the officer for the member id that will be on the dashboard card of the car they are currently checking. The automatic attendant will then tell the officer if the car still has any time left lot space or meter. The officer can the press 1 to enter in more member numbers or hang up to end the call.

3. Office Dispatcher: The officer can contact the office dispatcher. The dispatcher uses a PC connected to the internet to go to www.park-by-phone. He logs-in, checks the lot or meter and then can report back to the officer how much time is left, if any.

The payment module 20 is operatively connected to the data server module for processing member activity for a selected time frame and providing a billing of the member in response thereto. The payment module 20 processes parking unit activity for a selected time frame and provides payment to the client in response thereto utilizing the selected client information.

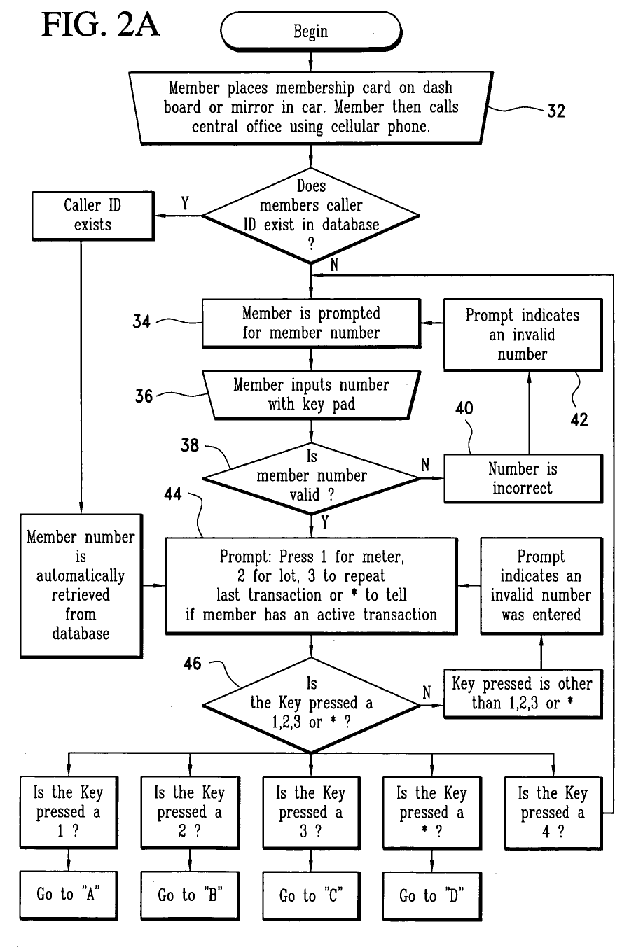

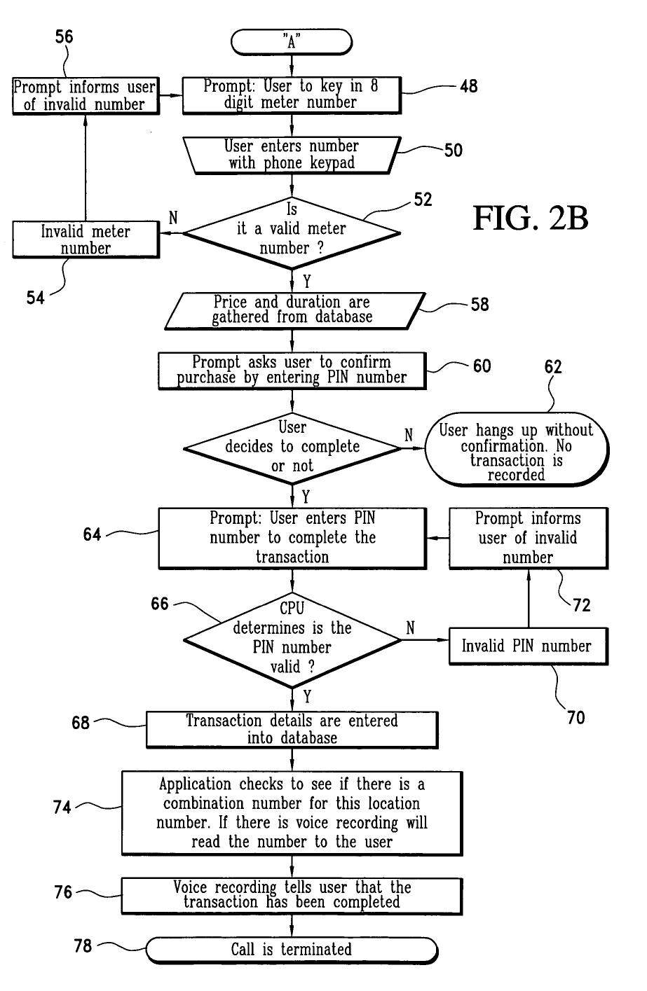

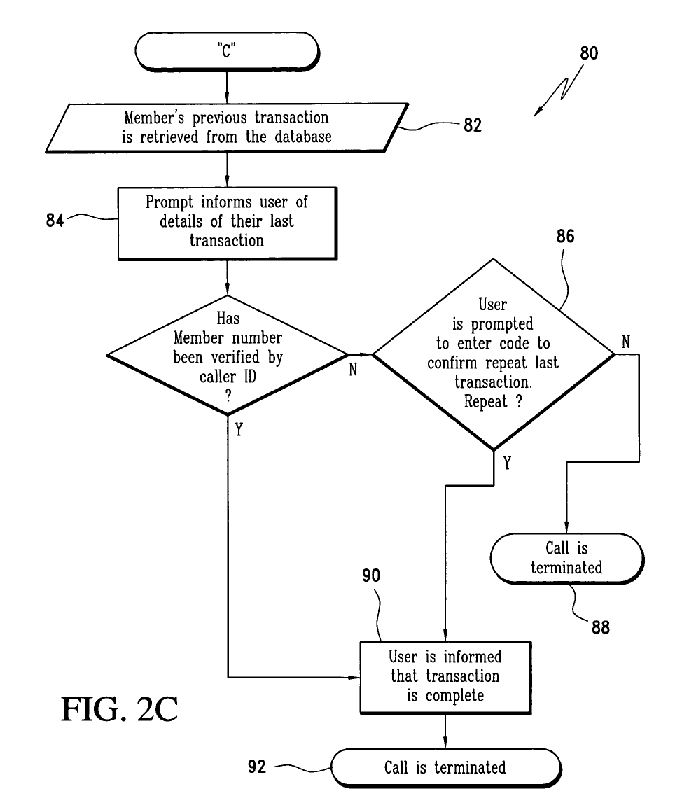

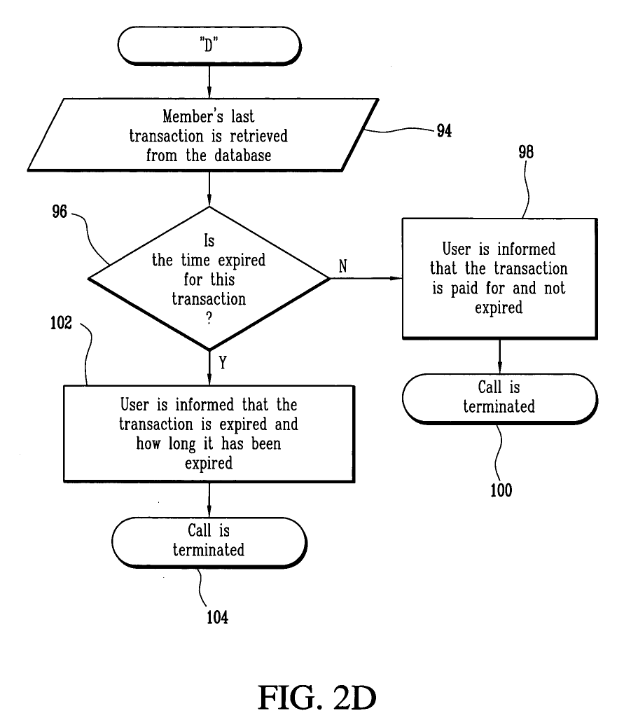

Referring now to FIG. 2A, implementation of the automated parking module 16 by an interactive voice response (IVR) system, designated generally as 30 is illustrated. As a member parks he places a membership card on the dash board or car mirror. The member then calls a central office, typically using a cellular phone (32). If his membership is not identified by caller ID, he is then prompted for a member number (34). The member inputs his member number with the phone keypad (36). The automated parking module 16 evaluates whether the member number is valid (38). If the number is not valid (40) a prompt indicates an invalid number (42) and he is again directed to enter a member number (34). If the number is correct then the user is prompted to press 1 for a meter, 2 for a lot, 3 to repeat the last transaction or * to tell if the member has an active transaction (44). The IVR system 30 then determines which key is pressed (46). If a key other than the above is pressed than a prompt indicates that an invalid number was entered.

Referring now to FIG. 2B, if key 1 is pressed for a meter, the user is prompted to key in an 8 digit meter number (48). The user responds by entering a number with the phone keypad (50). The IVR system 30 determines whether the entered meter number is a valid one (52). If it is not a valid one (54) then the user is thus informed (56) and prompted to enter a meter number (48).

If the meter number is valid the price and duration of the transaction are gathered from the activity database 28 (58). The user is prompted to confirm a purchase by entering his PIN number (60). If the user is hangs up without confirmation then no transaction is recorded (62). Otherwise, the user is prompted to enter a PIN number to complete the transaction (64). A determination is made as to whether the PIN number is valid (66). If yes, the transaction details are entered into the activity database 28 (68). Otherwise, the user is informed of the invalid number (70, 72).

Certain secured meters and/or lots provide a combination number. The automated parking module 16 checks to see if there is a combination number for this location. If there is then a voice recording will read the number to the user (74). The voice recording tells the user that the transaction has been completed (76). Finally, the call is terminated (78).

Although discussed above with respect to a parking meter, the same flowchart applies equally with respect to a parking lot, if the key 2 is pressed.

Referring now to FIG. 2C, the automated parking module includes a “feed-the-meter” submodule, designated generally as 80. This submodule 80 is initiated if the user presses key 3 requesting that the previous transaction be repeated. This involves the first step of retrieving a user's previous transaction from the activity database (82). The next step involves informing the user of the details of his last transaction (84). The user is then prompted to enter a code to confirm a request to repeat the last transaction (86). If he does not enter the code the call is terminated (88). If he enters the code then the user is informed that the transaction is complete (90) and the call is then terminated (92).

Although discussed above with respect to an IVR application, this “feed-the-meter” attribute can be utilized in web based transaction by simply clicking a link on a webpage.

Referring now to FIG. 2D, if a user presses the key *, his last transaction is retrieved from the activity database (94). The automated parking module 16 makes a determination as to whether the time has expired for this transaction (96). If the time has not expired then the user is informed that the transaction is paid for and not expired (98) and the call is terminated (100). If the transaction has expired the user is informed as to how long it has been expired (102). The call is then terminated (104).

In operation, the system modules generally are in use as follows:

Member Sign-up Module—

Applicant will visit www.Park-by-Phone.com, click on the “Sign Up” link, and will be guided through the application process. During the Park-By-Phone.com™ member registration the user will be prompted to enter in the following fields: Name, Address, Phone, E-mail, and Payment Information. An annual member fee of (e.g. about $5.95) will be charged at the time of registration.

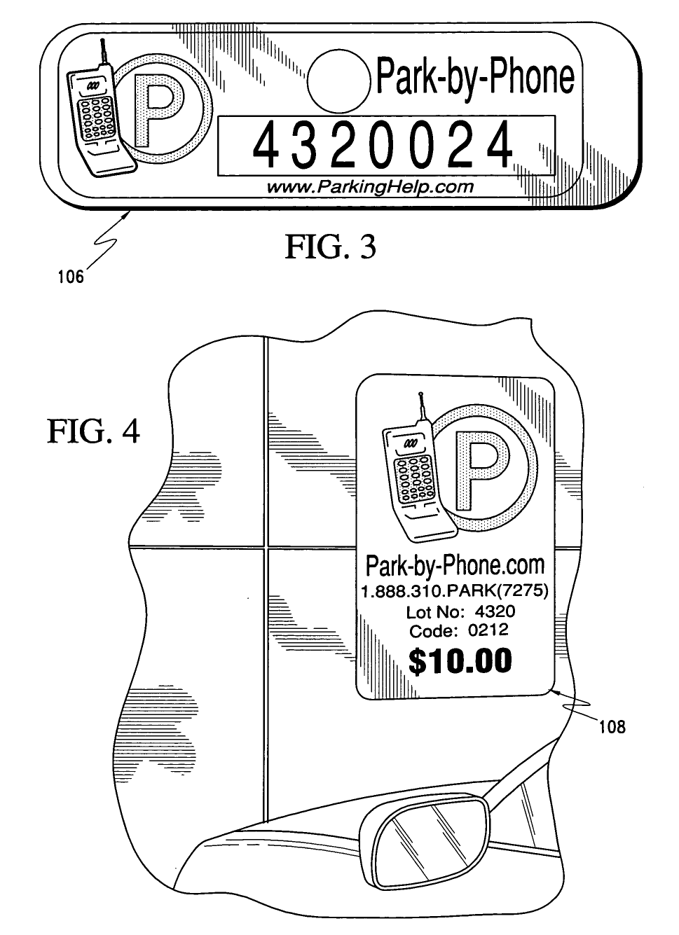

After the user has entered in the registration information and submitted the form the member will be sent an e-mail with a temporary membership dashboard card and a member number. An example dashboard card or hangtag is designated 106 in FIG. 3.

Parking Module—

When the customer parks in a lot with a Park-By-Phone.com™ lot sign, designated 108 (FIG. 4), or a meter sign (not shown) with a Park-By-Phone.com™ meter label he simply places the Park-By-Phone.com™ card 106 on the car's dashboard or hangs the card 106 from the rearview mirror and calls the Park-By-Phone.com™ telephone number. (The meter sign is essentially the same as the lot sign; however, it is obviously a much smaller size.)

The Park-By-Phone.com™ automated attendant prompts the member for his member number from the dashboard card.

If the member number is recognized then the Park-By-Phone.com™ automated attendant prompts the user for the lot or meter number. The member may “repeat last transaction” for meter feeding or if parked in the same location when Park-by-Phone was last used.

If the lot or meter number is recognized then the Park-By-Phone.com™ automated attendant returns the parking duration and fee.

The Park-By-Phone.com™ automated teller then prompts the user for the 4-digit PIN number that was sent to the member via e-mail. If the 4-digit PIN number is entered correctly the members account is updated.

Members can “Feed the Meter”—For example, if you are in a meeting and you know your meter/lot space is about to expire and you want to avoid a ticket, all you need to do is call Park-By-Phone.com™, or go online to www.park-by-phone.com and buy more time for your meter or lot space.

Payment Module—Customers are typically charged automatically on a monthly basis. The member can log-on to Park-By-Phone.com™ at anytime and view his monthly statements. A monthly activity report is issued that shows the date, invoice, event/location, and fee for all transactions of the current month. An account statement shows the date, invoice, event/location, and fee for any previous months transactions.

Enforcement Module—When an enforcement officer checks lots and meters he has three methods of validating the amount of time a car has left at the lot or meter:

1. Internet enabled Mobile Phone, Internet enabled wrist watch or PDA: Officer uses a web enabled phone to connect to the internet. The officer enters in a user name, and password to log-in. After he is logged in he can enter in the Group Event ID to view all vehicles currently active in the lot.

2. Mobile phone dial in: Officer uses mobile phone to dial a specific call in number. An automatic attendant prompts the officer for the member id that will be on the dashboard card of the car the officer is currently checking. The automatic attendant will then tell the officer if the car still has any time left lot space or meter. The officer can the press 1 to enter in more member numbers or hang up to end the call.

3. Office Dispatcher: The officer can contact the office dispatcher. The dispatcher uses a PC connected to the internet to go to www.park-by-phone. He logs-in, checks the lot or meter and then can report back to the officer how much time is left, if any.

Other embodiments and configurations may be devised without departing from the spirit of the invention and the scope of the appended claims.

1. An automated parking system, comprising:
a) a data server module, comprising:
i. a member information database for storing selected member information; and,
ii. a client information database for storing selected client information;
iii. a location database for containing listings of parking units administered by the automated parking system; and,
iv. an activity database for containing a listing of parking unit and member activity;
b) an internet-based sign up module operatively connected to said member information database for entering and processing new selected member information and providing private member identification information, said private member identification information including a member identifier and personal identifier;
c) an automated parking module for implementing the steps of:
i. determining whether a user is a valid member based on said selected member information in response to a placed parking unit inquiry;
ii. prompting the user for a parking unit identifier if the user is a valid member;
iii. determining if said parking unit identifier is valid based on parking unit listings in said location database and prompting the user to confirm a purchase by entering a personal identifier; and,
iv. completing the transaction if the correct personal identifier is entered;
d) an enforcement module operatively connected to said data server module for checking selected parking units and validating the amount of time a member can park in a specific parking unit based on said activity data; and,
e) a payment module operatively connected to said data server module for processing member activity for a selected time frame and providing a billing of said member in response thereto; and, for processing parking unit activity for a selected time frame and providing payment to the client in response thereto utilizing said selected client information.

2. The automated parking system of claim 1 wherein said data server module, internet-based sign up module, automated parking module, enforcement module, and payment module reside in computer systems.

3. The automated parking system of claim 1 wherein said parking units comprise parking lots.

4. The automated parking system of claim 1 wherein said parking units comprise parking meters.

5. The automated parking system of claim 1 wherein said selected member information comprises the member's name, address, and phone number.

6. The automated parking system of claim 1 wherein said selected client information comprises the client's name, address, and phone number.

7. The automated parking system of claim 1 wherein each parking unit in said location database comprises a parking unit identifier, a client name, and a fee associated with a time period.

8. The automated parking system of claim 1 wherein said activity database comprises activity database fields, said activity database fields comprising: a member ID field, a date/time field, a fee field and an identification field of the parking unit.

9. The automated parking system of claim 1 wherein said member identifier comprises a member number.

10. The automated parking system of claim 1 wherein said parking unit inquiry comprises a telephone inquiry.

11. The automated parking system of claim 1 wherein said parking unit inquiry comprises an internet inquiry.

12. The automated parking system of claim 1 wherein said parking unit inquiry comprises an PDA (personal digital assistant) inquiry.

13. The automated parking system of claim 1 wherein said parking unit inquiry comprises a wireless communication device inquiry.

14. The automated parking system of claim 1 wherein said automated parking module comprises an interactive voice response (IVR) system.

15. The automated parking system of claim 1 wherein said automated parking module further includes a “feed-the-meter” submodule for implementing the steps of:
i. retrieving a user's previous transaction from said activity database upon a user's request;
ii. informing the user of the details of his last transaction;
iii. prompting the user to enter a code to confirm a request to repeat the last transaction; and,
iv. informing the user that the transaction is complete if the request is confirmed.

16. The automated parking system of claim 1 wherein said automated parking module further includes a “feed-the-meter” submodule for adding time to a parking unit by clicking a link on a webpage.

17. The automated parking system of claim 1 wherein said automated parking module implements the step of determining whether a user is a valid member based on said selected member information by the step of;
determining if a member's caller ID exists in the database and retrieving said member number if it exists.

18. The automated parking system of claim 1 wherein said automated parking module implements the step of determining whether a user is a valid member based on said selected member information by the steps of;
a) prompting a user for said member identifier; and,
b) determining if said member identifier is valid based on said selected member information.

19. The automated parking system of claim 1 wherein said automated parking module implements the step of determining whether a user is a valid member based on said selected member information by the steps of;
a) determining if a member's caller ID exists in the database and retrieving said member number if it exists;
b) prompting a user for said member identifier if no caller ID exists in the database; and,
c) determining if said member identifier is valid based on said selected member information.

20. A method for providing automated parking, comprising the steps of:
a) storing selected member information in a member information database;
b) storing selected client information in a client information database;
c) storing listings of parking units administered by the automated parking system in a location database;
d) storing listings of parking unit and member activity in an activity database;
e) entering and processing new selected member information and providing private member identification information, said private member identification information including a member identifier and personal identifier;
f) providing an automated parking module that implements the steps of:
i. determining whether a user is a valid member based on said selected member information in response to a placed parking unit inquiry;
ii. prompting the user for a parking unit identifier if the user is a valid member;
iii. determining if said parking unit identifier is valid based on parking unit listings in said location database and prompting the user to confirm a purchase by entering a personal identifier; and,
iv. completing the transaction if the correct personal identifier is entered;
g) checking selected parking units and validating the amount of time a member can park in a specific parking unit based on said activity data; and,
h) processing member activity for a selected time frame and providing a billing of said member in response thereto; and, processing parking unit activity for a selected time frame and providing payment to the client in response thereto utilizing said selected client information.

21. A method for providing interactive voice response (IVR) for an automated parking system, comprising the steps of:
a) prompting a user for a member identifier in response to a placed parking unit inquiry;
b) determining if said member identifier is valid;
c) prompting the user for a parking unit identifier if said member identifier is valid;
d) determining if said parking unit identifier is valid and prompting the user to confirm a purchase by entering a personal identifier; and,
e) completing the transaction if the correct personal identifier is entered.

22. The method of claim 21, further comprising the steps of:
a) retrieving a user's previous transaction from an activity database upon a user's request, said activity database containing a listing of parking unit and member activity;
b) informing the user of the details of his last transaction;
c) prompting the user to enter a code to confirm a request to repeat the last transaction; and,
d) informing the user that the transaction is complete if the request is confirmed.

23. The method of claim 21, further comprising the steps of:
a) checking to see if there is a combination number for a location after a correct personal identifier is entered; and,
b) reading said combination number with a voice recording to the user if there is such a combination number.

24. The method of claim 21, further comprising the steps of:
a) retrieving a user's last transaction from an activity database upon a user's request, said activity database containing a listing of parking unit and member activity;
b) making a determination as to whether the time has expired for said last transaction
c) informing the user that the time has not expired if the time has not expired; and,
d) informing the user how long it has been expired if the transaction has expired.

25. The method of claim 21, further comprising the step of reprompting said user if said member identifier is not valid.
